(19) United States
(12) Patent Application Publication
(10) Pub. No.: US 2025/0145247 A1
(43) Pub. Date: May 8, 2025

(54) DRIVE SYSTEM FOR AN ELECTRIC BICYCLE, WITH CALCULATION OF A TORQUE AT THE BOTTOM BRACKET SPINDLE FOR CONTROLLING THE ASSISTANCE POWER

(71) Applicant: BROSE ANTRIEBSTECHNIK GMBH & CO. KOMMANDITGESELLSCHAFT, BERLIN, Berlin (DE)

(72) Inventor: Elmar HOPPACH, Wuerzburg (DE)

(21) Appl. No.: 18/833,361

(22) PCT Filed: Jan. 24, 2023
(86) PCT No.: PCT/EP2023/051597

§ 371 Date: Oct. 28, 2024

(30) Foreign Application Priority Data
Jan. 28, 2022 (DE) 10 2022 102 070.3

(51) Int. Cl. B62M 6/50; B62J 45/20

(52) U.S. Cl. CPC B62M 6/50; B62J 45/20

(57) ABSTRACT

It is provided a drive system for an electric bicycle, said drive system comprising: at least one acceleration sensor for providing an acceleration signal that is representative of the acceleration of the electric bicycle, and at least one rotation angle sensor for providing a rotational speed signal that is representative of a rotational speed of a bottom bracket shaft. An electronic control unit provided for controlling a drive motor of the electric bicycle is configured to use the acceleration signal and the rotational speed signal to calculate a torque applied to the bottom bracket shaft by muscle power and to control an assistance power provided by the drive motor on the basis of the calculated torque.

### CROSS REFERENCE TO RELATED APPLICATIONS

The present application is a U.S. National Phase of International Application No. PCT/EP2023/051597 entitled “DRIVE SYSTEM FOR AN ELECTRIC BICYCLE, WITH CALCULATION OF A TORQUE AT THE BOTTOM BRACKET SPINDLE FOR CONTROLLING THE ASSISTANCE POWER,” and filed on Jan. 24, 2023. International Application No. PCT/EP2023/051597 claims priority to German Patent Application No. 10 2022 102 070.3 filed on Jan. 28, 2022. The entire contents of each of the above-listed applications are hereby incorporated by reference for all purposes.

### BACKGROUND

The proposed solution relates in particular to a drive system for an electric bicycle, and to a method for controlling a drive system of this kind.

Drive systems for electric bicycles (e.g., e-bike or pedelec) comprising at least one electric motor for generating an additional drive torque by external power, and thus for providing an assistance power in addition to a drive power applied by muscle power, are widely known. For example, drive systems comprising electric motors are known from DE 10 2018 001 795 A1 and DE 10 2019 201 812 B3, which drive systems allow for stepless adjustment of a transmission between a drive and an output. In this case, a planetary gear is in each case part of the drive system, wherein changes of the transmission are controlled by a first electric motor. The assistance power for the output is provided via a further electric motor, and at the same time compensates an actuating power arising at the first electric motor, in order to allow for operation of the drive system without supplying additional power from an energy store.

A drive system is known from DE 10 2016 223 410 A1 which allows for stepless adjustment of a gear reduction and the provision of an assistance power using just one electric motor.

In practice, it is conventional to make the assistance power, and thus the magnitude thereof, dependent on a wish of a rider. This wish of a rider is determined via measuring a torque currently applied by muscle power to the bottom bracket shaft of the drive system. The harder a rider of the electric bicycle presses on the pedals connected to the bottom bracket shaft, the higher the assistance power is selected, in order to accelerate the electric bicycle in a motor-assisted manner. For measuring the actual torque applied by muscle power, typically a torque sensor is provided on the bottom bracket shaft. This enables direct measurement of the torque actually applied to the bottom bracket shaft, for example on the basis of an inverse magnetoelastic effect or using at least one strain gauge.

However, the direct measurement of the torque actually applied is comparatively costly, in any case in relation to other sensors and the overall costs of the drive system. A torque sensor furthermore requires a comparatively large amount of installation volume in the region of the bottom bracket shaft. A possible malfunction or even a failure of the torque sensor is furthermore also directly associated with significantly reduced travel comfort, since an assistance power can no longer be automatically adjusted in a useful manner. Therefore, the motorized assistance is frequently suspended in the event of a fault of the torque sensor being identified, such that no more assistance power is available until the torque sensor has been repaired.

### SUMMARY

Against this background, the problem addressed by the proposed solution is that of improving drive systems known hitherto and control methods provided therefor, and at least reducing the above-mentioned disadvantages.

This problem is solved both by a drive system having features as described herein and by a control method having features as described herein.

A proposed drive system comprises at least one acceleration sensor for providing an acceleration signal that is representative of the acceleration of the electric bicycle, and at least one rotation angle sensor for providing a rotational speed signal that is representative of a rotational speed of the bottom bracket shaft. An electronic control unit provided for controlling at least one drive motor of the electric bicycle is configured to use the acceleration signal and the rotational speed signal to calculate a torque applied to the bottom bracket shaft by muscle power and to control an assistance power provided by the at least one drive motor on the basis of this calculated torque.

The basic principle of the proposed solution is therefore that of indirectly determining a torque at the bottom bracket shaft that is representative of the (current) drive power of a rider of the electric bicycle, and of providing it for the control of the assistance power. For example, the calculation on the basis of the acceleration signal and of the rotational speed signal provides a torque signal for the calculated torque which can be included in the specification of the assistance power via the at least one drive motor. The use of an indirect method for determining the torque on the bottom bracket shaft applied by muscle power (often also referred to as “pedomotive torque”) on the basis of the acceleration signal and the rotational speed signal that is decisive for an angular position of the bottom bracket shaft can be implemented more cost-effectively, in this case, than a direct measurement with the aid of a torque sensor. For example, a rotation angle sensor many times cheaper than a torque sensor, and also requires significantly less installation space. It has been shown that the torque applied to the bottom bracket shaft by muscle power can be estimated comparatively well in a processor-assisted manner, via an indirect measuring method on the basis of an (optionally continuous) measurement of the current acceleration of the electric bicycle and an (optionally continuous) measurement of an angle of rotation of the rotating bottom bracket shaft, in particular can be estimated so quickly and robustly that the control of the assistance powers can take place thereby, optionally also alone. The calculated torque or a signal that can be traced back to this can, however, in principle be used not only alternatively, but rather also in addition, to a measurement signal of a torque sensor, provided on the bottom bracket shaft, for controlling the assistance powers.

In a variant, a mathematical model is stored in the electronic control unit, via which model a calculation of the torque at the bottom bracket shaft is made possible from the acceleration signal and the rotational speed signal. This mathematical model, which is implemented on the software side via an algorithm in control logics of the electronic control unit, makes it possible to determine a torque signal for the calculated torque only from the acceleration signal and the rotational speed signal.

In a first approximation, for example a Fourier transform having a predetermined window function can be used for calculating the torque within the mathematical model. For example, in this case the use of a Hamming window, for example over a time region of 3 seconds, 5 seconds or 7 seconds has been found to be advantageous. With a view to a quicker calculation of a torque signal usable for controlling the at least one drive motor, in a development the use of a sine transformation and/or a cosine transformation for the measured acceleration signal is considered advantageous. The mathematical model stored in the electronic control unit for calculating the torque then comprises a sine transformer and/or a cosine transformer, via which the acceleration signal for calculating the torque (and thus a torque signal for the calculated torque) is supplied to a sine formation and/or a cosine transformation. Then, for an acceleration signal f over time t, for example a sine formation and a cosine transformation are specified as follows:

$${Y}_{s} ( f ) = SIN \{ y ( t ) \} = {\int }_{- ∞}^{∞} y ( t ) sin ( 2 π f t ) dt ,$$

$${Y}_{C} ( f ) = COS \{ y ( t ) \} = {\int }_{- ∞}^{∞} y ( t ) cos ( 2 π f t ) d t .$$

In this case, both terms inserted above have the general spatial frequency 2πft in the integral. In this case, for determining the torque at the bottom bracket shaft, the function Y_{S,C} (f) is expedient as an integral over one or half a rotation of the bottom bracket shaft, assuming that a rider of the electric bicycle is pushing the pedals, connected to the bottom bracket shaft, with the same force with both legs (where Y_{S,C}=Y_{S}(f)−j·Y_{c}(f)). Here, the sine or cosine transformation can then be carried out only for the relevant spatial frequency of the rotational speed of the bottom bracket shaft. In the case of an unknown phase position, carrying out both the sine transformation and also the cosine transformation is advisable. For example, according to the proposed solution the position and the rotational speed of the bottom bracket shaft can be used to synchronize the transformation to the length of half a multiple of the rotation of the bottom bracket shaft. If the phase position is for example known from indexing, the function Y_{S, C}(f) can be divided into even and odd signals or signal values, in order to simplify these to a sine transformation or cosine transformation. In any case, using a sine transformation and/or a cosine transformation of the acceleration signal, a comparatively very quick estimation, with a good degree of accuracy, of the torque applied to the bottom bracket shaft by muscle power is possible in a processor-assisted manner, such that the assistance power of the at least one drive motor of the electric bicycle can be effectively controlled thereby.

As already explained above, the proposed solution in particular includes the situation that, in a variant, an assistance power provided by the at least one drive motor is dependent exclusively on a torque signal calculated on the basis of an acceleration signal and a rotational speed signal. In this case, it is then accepted, for example for a cost and weight advantage, that the underlying indirect measurement method is slightly less precise than a direct measurement of the torque, actually applied to the bottom bracket shaft by muscle power, using at least one torque sensor.

Alternatively, however, the drive system can also additionally comprise at least one torque sensor for measuring the actual torque currently applied to the bottom bracket shaft by muscle power. Thus, in a drive system of this kind, furthermore at least one torque sensor for direct, sensor-based measurement of the actual torque is provided, but additionally also a processor-assisted calculation of a torque according to the proposed solution is carried out. In a development based on this, the electronic control unit can then be configured to use the measured actual torque (or a measurement signal for the actual torque) for controlling the assistance power, and to use the calculated torque for checking the plausibility of the measurement of the actual torque by the at least one torque sensor. Therefore, here, too, the control of the assistance power is based on the calculated torque. However, the calculated torque is used in the control of the assistance power (primarily or exclusively) for checking the plausibility of the actually measured torque. If an (absolute) deviation above a tolerance value, or a cluster of such deviations above a threshold value between the actual measured torque and the calculated torque means that an error, or even a failure, of the torque sensor can be concluded, then the control electronics is configured to generate an error signal. The calculated torque thus makes it possible to more quickly electronically identify a possible malfunction of the torque sensor, in particular before complete failure of the torque sensor.

In principle, in the context of the proposed solution, a mutual improvement of the accuracy of torque sensors having different operating principles is also possible. Such a system design, which is based on what is known as sensor fusion, can be used for example to supplement a torque system accessing just one pedal, to a two-side operating mode.

Alternatively or in addition, the calculated torque can be usable for providing a second operating mode of the drive system, in which then the magnitude of the provided assistance power is no longer dependent on the measurement signal of the torque sensor, but rather on the calculated torque. In this case, the drive system is therefore capable of using the calculated torque if required, in particular in the case of an identified malfunction or a failure of the torque sensor, in order to thereby be able to provide a rider of the electric bicycle with an assistance power and thus continue to be able to provide a degree of travel comfort. In this case, the drive system can consequently be operable in at least a first operating mode and at least a second operating mode, wherein in the at least one first operating mode the assistance power is dependent on the actual torque measured by the at least one torque sensor (and thus a measurement signal of the at least one torque sensor), and in the at least one second operating mode the assistance power is dependent on the calculated torque (and thus a torque signal determined using this). Thus, switching, if required, between different operating modes and thus control scenarios is possible via the control electronics, depending on the basis on which the control of the assistance power is intended to take place. For example, depending on the control scenario for the assistance power, a direct or indirect method for determining the torque at the bottom bracket shaft can be usable.

In particular, in this connection, the electronic control unit can be configured, in the event of an (in particular electronically detected) malfunction or a failure of the at least one torque sensor, to switch, in a user-controlled manner, i.e. in response to a switching signal triggered by a user, or automatically, from the first operating mode into the second operating mode. In this way, a redundant system having a fallback level is provided, in which the control of the assistance power can depend on an indirectly determined torque at the bottom bracket shaft. Although the indirect method, used here, for determining the torque is possibly less exact than the indirect measurement of the actually applied torque, which is also possible, this makes it possible, in the case of a malfunction or a failure of the at least one torque sensor on the bottom bracket shaft, to allow a rider of the electric bicycle to at least continue to use the at least one drive motor. In this case, the usability of the calculated torque in a second operating mode can of course also be combined with the use, explained above, of the calculated torque for checking the plausibility of the measured torque. In the first operating mode the calculated torque can thus serve primarily for checking the plausibility. Secondarily, in the second operating mode the calculated torque is provided for controlling the assistance power when the torque sensor malfunctions or fails.

In principle, the magnitude of the assistance power can also depend on an assistance level that is adjustable, in particular adjustable based on the travel situation. In this case, depending on the adjusted assistance level, a specific (firmly specified) amount of assistance power is provided depending on the drive power applied via the bottom bracket shaft and accordingly depending on the torque applied by muscle power. In this case, the aim is to enable a user/rider of the electric bicycle to drive and accelerate the electric bicycle with comparatively moderate drive power applied by muscle power, up to a maximum speed of for example 25 km/h.

The at least one drive motor can be actuatable via the control unit for providing an assistance power which corresponds to the drive power currently applied by muscle power to the bottom bracket shaft, multiplied by a factor predetermined via the control unit. For example, an assistance power in a magnitude of 0.3 times, 1.0 times, 1.5 times or 2.5 times the currently applied drive power can be provided, depending on the assistance level. In this case, the factor can be predetermined in stages. The control unit can in particular vary the magnitude of the assistance power to be provided via the size of this factor. The factor of the assistance power is thus optionally dynamically adjustable to a travel situation of the electric bicycle.

The proposed solution furthermore also comprises an electric bicycle comprising a variant of a proposed drive system.

Furthermore, the proposed solution extends to a control method for a drive system of an electric bicycle. In this case, a torque applied to the bottom bracket shaft by muscle power is calculated using an acceleration signal representative of the acceleration of the electric bicycle and a rotational speed signal representative of a rotational speed of the bottom bracket shaft, and the assistance power of at least one drive motor of the drive system is controlled on the basis of the calculated torque.

A variant of a proposed control method can thus be implemented in particular by a variant of a proposed drive system. Features and advantages explained above and below in connection with variants of a proposed drive system therefore also apply for variants of a proposed control method, and vice versa.

Thus, for example, in the course of a proposed control method the torque can be calculated with the aid of a mathematical model which includes the acceleration signal and the rotational speed signal as input variables. A sine transformation and/or a cosine transformation of the acceleration signal can be performed by the stored mathematical model for calculating the torque (and thus a torque signal for the calculated torque).

Analogously to the variant described above for a proposed drive system, in a variant of a proposed control method the drive system can also additionally comprise at least one torque sensor for (direct) measurement of a torque currently actually applied by muscle power to the bottom bracket shaft. For controlling the assistance power the measured actual torque can then be used, wherein the plausibility of this measurement of the actual torque is checked by the at least one torque sensor with the calculated torque (continuously or at discrete time points).

Alternatively or in addition, the drive system can be operable in at least a first operating mode and in at least a second operating mode, wherein in the at least one first operating mode the assistance power is dependent on the actual torque measured by the at least one torque sensor, and in the at least one second operating mode the assistance power is dependent on the calculated torque. Thus, if necessary, switching between different control scenarios is possible, as has already been explained above in connection with a variant of a proposed drive system. In particular, in this case, in the event of a malfunction or a failure of the at least one torque sensor it is possible to switch between the different operating modes.

The proposed solution further comprises a computer program product which comprises instructions which, when executed by at least one processor of an electronic control unit for a drive system of an electric bicycle, cause the at least one processor to carry out a variant of a proposed method.

### BRIEF DESCRIPTION OF THE DRAWINGS

The accompanying drawings illustrate possible variants, by way of example, of the proposed solution,

in which:

FIG. 1 is a schematic view of an electric bicycle in which the proposed solution is used, illustrating acquisition of measured data for the development of a mathematical model implemented subsequently in control electronics of a drive system of the electric bicycle, with the aid of which model a torque applied by muscle power to a bottom bracket shaft of the electric bicycle is estimated in a processor-assisted manner, exclusively on the basis of an acceleration signal and a rotational speed signal.

FIG. 2 is a graph in which a travel speed is plotted against time, for a test ride with the electric bicycle of FIG. 1.

FIG. 3A is a graph in which measured data for acceleration values measured using an inertial measurement unit of the electric bicycle of FIG. 1 are shown against time, for the test ride.

FIG. 3B is a graph in which the calculated moving averages for the measured data of FIG. 3A are plotted against time.

FIG. 4 is a three-dimensional graph of the measured data for the acceleration in a direction of travel after a Fourier transform, wherein in the graph of FIG. 4, for a calculated Fourier transform, the amplitudes are plotted against frequency and time.

FIG. 5 shows measured data of an acceleration signal plotted for a journey of the electric bicycle.

FIG. 6 is a graph in which torque values calculated from the measured data of FIG. 5 are plotted against time.

FIG. 7 is a graph in which calculated torque values are compared with measured torque values for the travel with the electric bicycle.

FIG. 8 shows a detail of parts of a variant of a proposed drive system comprising an electronic control unit which implements a mathematical model on the software side.

### DETAILED DESCRIPTION

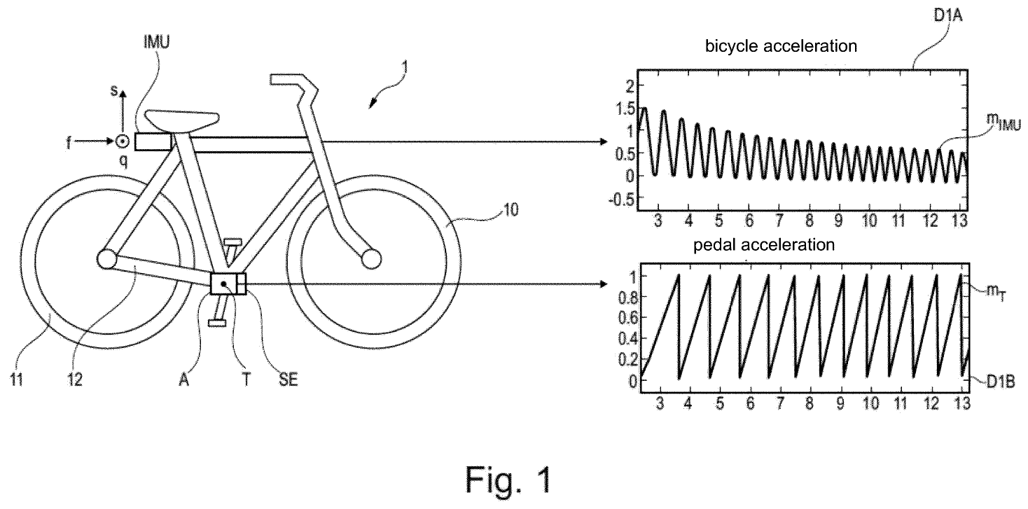

FIG. 1 shows a variant of a proposed electric bicycle 1 comprising a front wheel 10 and a back wheel 11, wherein the back wheel 11 can be driven in an electromotively assisted manner via at least one drive motor A of a drive system. An assistance power can be transmitted to the rear wheel 11 by the drive motor A, via a force transmission element, for example a chain 12. In this case, the assistance power of the drive motor A is provided in addition to a drive power, which a rider of the electric bicycle 1 applies by muscle power via pedals of the electric bicycle 1 connected to a bottom bracket shaft T. The assistance power provided via the drive motor A, or the magnitude thereof, is controlled via an electronic control unit SE of the drive system. In this case, the provided assistance power is intended to depend in particular on what torque the rider of the electric bicycle 1 applies to the bottom bracket shaft T.

With the aim of indirectly determining the torque applied by muscle power to the bottom bracket shaft T, i.e. without measuring the actual torque with the aid of at least one torque sensor provided on the bottom bracket shaft T, the electric bicycle 1 of FIG. 1 is equipped with an inertial measuring unit IMU, via which an acceleration of the electric bicycle 1 can be measured. In this case, the inertial measuring unit IMU is capable, in addition to measuring the acceleration of the electric bicycle 1 in a direction of travel f, of also measuring accelerations in the transverse direction q and in the vertical direction s. An acceleration measurement by way of example using measured data m_{IMU} provided by the international measuring unit IMU is illustrated in a graph DIA of FIG. 1.

In addition, the drive system of the electric bicycle 1 of FIG. 1 comprises a rotation angle sensor via which an angular position and thus a rotational speed of the bottom bracket shaft T can be measured. Measured data mr provided by the rotation angle sensor during travel with the electric bicycle 1 are illustrated by way of example on the basis of a graph DIB of FIG. 1.

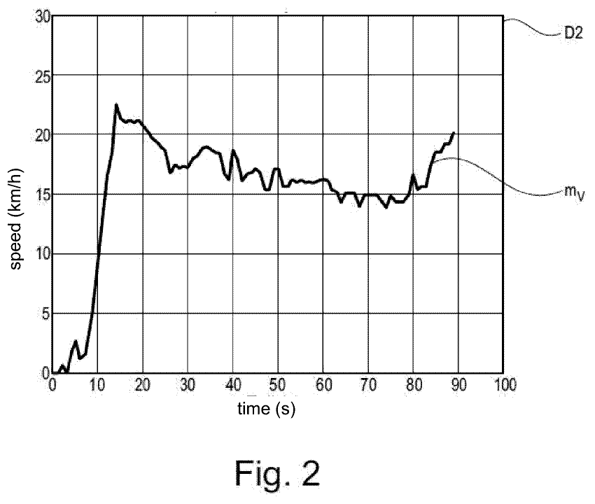

For the development of a mathematical model by means of which a torque applied by muscle power to the bottom bracket shaft T can be concluded in an effective, i.e. sufficiently quick and sufficiently precise manner, merely from an acceleration signal representative of the acceleration of the electric bicycle 1 and a rotational speed signal representative of the rotational speed of the bottom bracket shaft T, a test ride is performed using the electric bicycle 1. This test ride extends for example over approximately 400 m. The test distance provided for this has a flat course at the start and then transitions into a 4 percent gradient. The gradient is followed by 100 m of flat travel, at the end of which an approx. 50 m long slight downhill slope follows, during which a rider of the electric bicycle 1 does not push the pedals connected to the bottom bracket shaft T. For this test distance, a course of measured data my acquired for the travel speed, as is shown in the graph D2 of FIG. 2, results for a measured travel speed v of the electric bicycle 1.

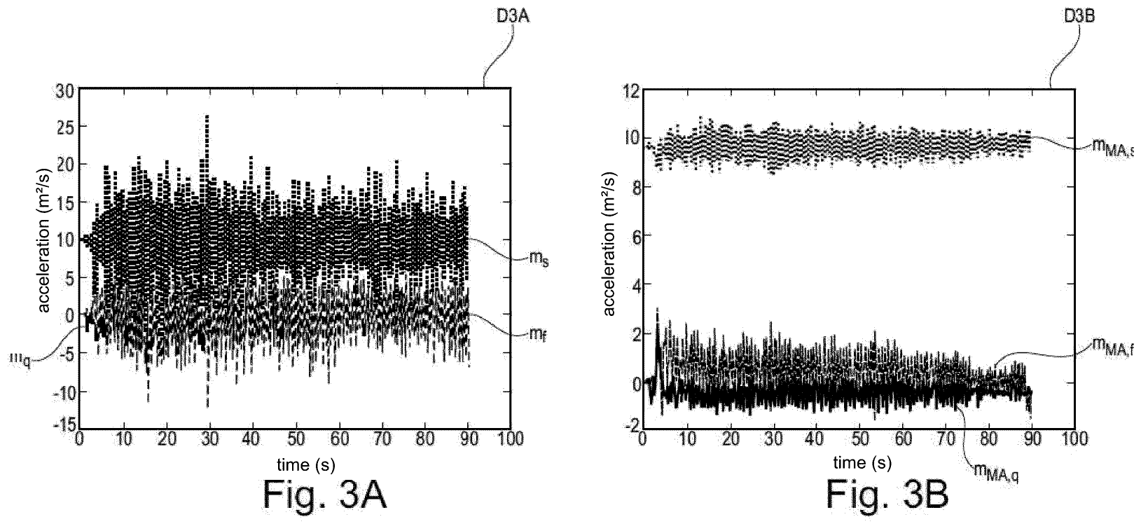

For the test ride with the electric bicycle 1, measured values for the accelerations of the electric bicycle 1 in the direction of travel f, transverse direction q and vertical direction s were acquired by the inertial measurement unit IMU, which is used here as an acceleration sensor having a scanning rate of 100 Hz. Measured data m_{f} for the accelerations in direction of travel f, measured data m_{q} for the accelerations in the transverse direction q and measured data mₛ for the accelerations in the vertical direction s for the test ride are plotted against time in the graph D3A of FIG. 3A 3.

Filtered signals are determined from these raw signals, for the different accelerations. In this case, the graph D3B of FIG. 3B shows determined moving average values m_{MA,f}, m_{MA,q} and m_{MA,s} for the measured data m_{f}, m_{q} and mₛ of FIG. 3A, plotted over time (10 filter points).

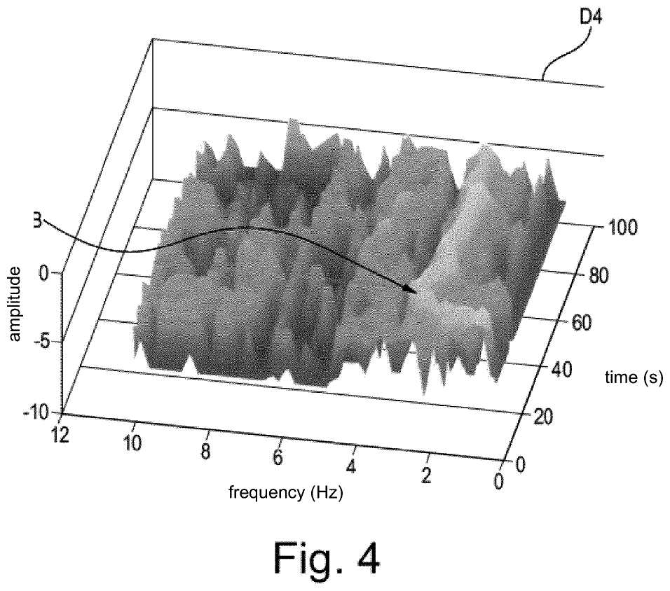

The graph of FIG. 4 can be obtained from the (filtered) acceleration signal for the direction of travel f, from a Fourier transform having a Hamming window and a window width of 5 seconds. Here, the amplitude of the function obtained from the Fourier transform is plotted over the frequency and the time. As is to be expected, a signal of twice the frequency of the bottom bracket shaft speed, here from approximately 2.5 Hz to 3 Hz, appears in a signal region B, since the rider of the electric bicycle 1 in the present case has pushed the pedals at a cadence of 80 rotations per minute during the test ride. It can be seen that, in the function obtained by the Fourier transform, or a signal determined thereby, the increase in the rotational speed upon start-up and the reduction in the amplitude at the end of the distance, and the transition to the flat in the last part of the test distance lead to significant changes and are thus visible. Thus, on this basis, the torque applied by muscle power to the bottom bracket shaft T can be concluded indirectly from the acceleration signal, in any case if the rotational speed of the bottom bracket shaft T is also known. The Fourier transform performed thus results in an evaluable signal from which, however, during actual operation of the electric bicycle 1, merely vibrations measured therewith have to be subtracted out.

The Fourier transform selected in a first approximation here

$$( ℱ f ) = \frac{1}{{\sqrt{2 π}}^{n}} {\int }_{{ℝ}^{n}} f ( x ) {e}^{- i y x} d x$$

with a Hamming window of over 5 seconds is, however, under some circumstances too slow for determining therefrom a torque signal since it can be expediently used for controlling the at least one drive motor A (in particular in view of the travel comfort for the rider of the electric bicycle 1). Against this background, it is provided in a variant for a real signal f of the acceleration sensor (e.g., of the acceleration sensor in the form of the inertial measuring unit IMU) to replace the Fourier transform by a sine and cosine transformation of the following form:

$${Y}_{s} ( f ) = SIN \{ y ( t ) \} = {\int }_{- ∞}^{∞} y ( t ) sin ( 2 π f t ) dt ,$$

$${Y}_{C} ( f ) = COS \{ y ( t ) \} = {\int }_{- ∞}^{∞} y ( t ) cos ( 2 π f t ) d t .$$

Both terms of the transformations inserted above have the general spatial frequency 2πft in the integral. However, for the calculation of the torque, the function Y_{S,C} (f) is to be set as an integral over one or half a rotation of the bottom bracket shaft T if the rider of the electric bicycle 1 is pushing the pedals with the same force with both legs. Thus, the sine or cosine transformation is carried out only for the relevant spatial frequency of the rotational speed of the bottom bracket shaft T. In the case of an unknown phase position, the sine and cosine transformation can be carried out. If the phase position, and thus any imbalance when pushing the pedals connected to the bottom bracket shaft T, for example by an index, is known, the function can be divided into even or odd, such that it is then simplified to a sine or cosine transformation.

Assuming this, it is possible to develop a system model of the electric bicycle 1 with its drive system, for example created using the software SIMULINK®, in which a mathematical model can be verified, by means of which the torque at the bottom bracket shaft T can be estimated from the acceleration signal and a rotational speed signal representative of the rotational speed of the bottom bracket shaft T. In this case, a system model of this kind can reproduce the relevant movement differential equations.

On the basis of the system model, the meaningfulness of a developed mathematical model MM can be verified, which model is then implemented for controlling the drive motor A in the electronic control unit SE. The mathematical model MM, which can be depicted e.g. in SIMULINK® by a plurality of continuous and discrete switching blocks, has, as input variables, an acceleration signal representative of the acceleration of the electric bicycle 1, and a rotational speed signal representative of the rotational speed of the bottom bracket shaft T. Part of the mathematical model MM is in particular a sine/cosine transformer, via which the sine and/or cosine transformation of the acceleration signal, explained above, is carried out. As a starting variable the mathematical model MM, which is implemented on the software side via a corresponding algorithm in the electronic control unit SE, outputs a calculated torque and thus a typically continuous torque signal from this which can be used for controlling the drive motor A, on the basis of calculated torque values.

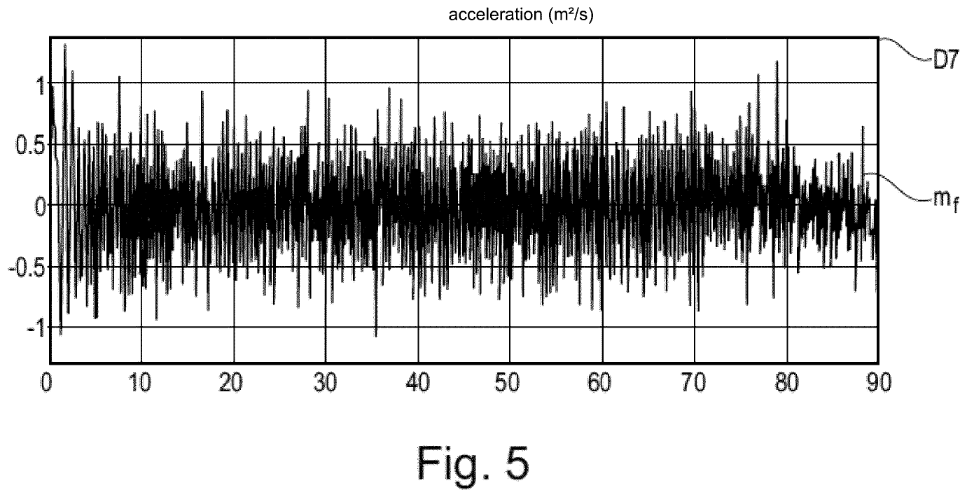

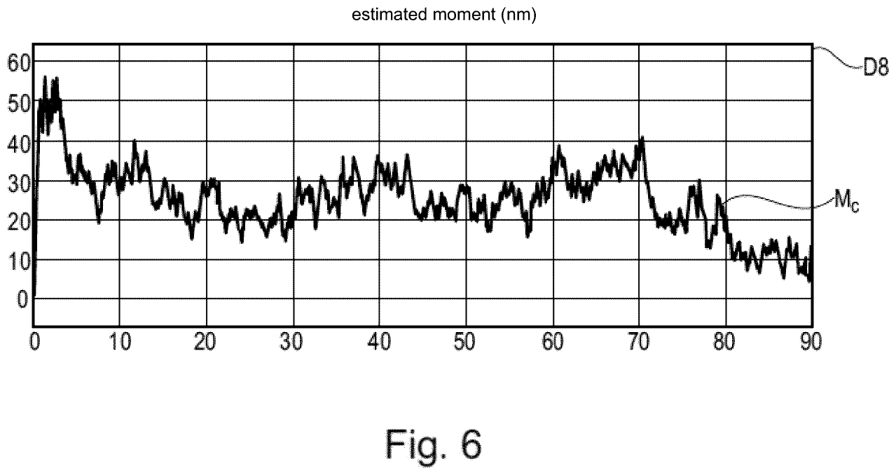

This then results, for example for measured accelerations in the direction of travel f, in the case of travel of the electric bicycle 1, in a course of measured data mr corresponding to the graph D7 of FIG. 5, and from this in turn a course of a calculated torque M_{c}, which is illustrated in the graph D8 of FIG. 6.

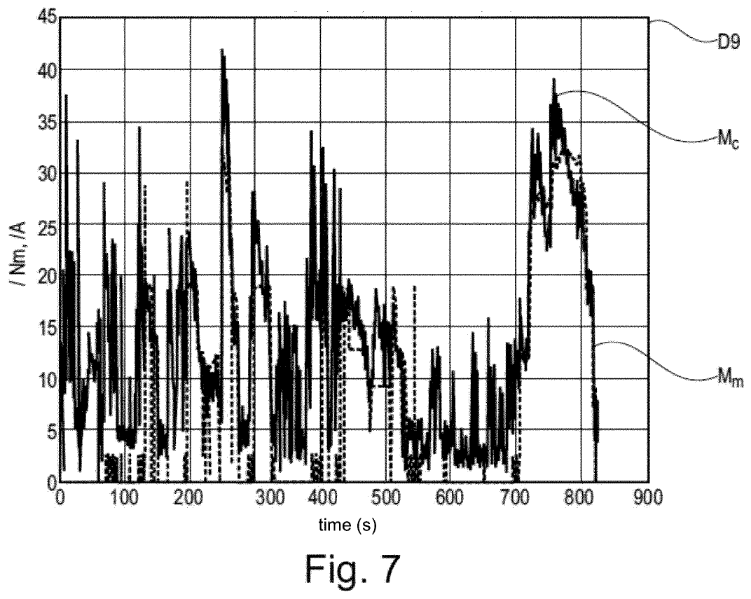

If the course of the calculated torque M_{c} is compared with a course of a course, measured with the aid of a torque sensor, of torque Mₘ actually applied to the bottom bracket shaft T, according to the graph D9 of FIG. 7, it can be seen that the calculated, and thus estimated, values for the torque M_{c} correspond well, qualitatively and in part also quantitatively, with the measured values for the actual torque Mₘ. The calculated torque M_{c} can thus readily be used for specifying the magnitude of the assistance power applied by the drive motor A. A lower accuracy in the estimated value for the torque, which may possibly have to be accepted here, is countered in this case by reduced costs and lower weight compared with the use of a torque sensor on the bottom bracket shaft T.

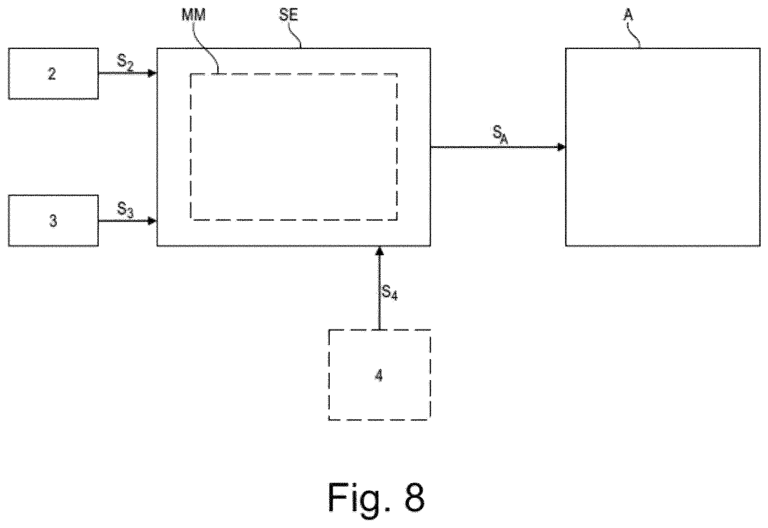

Thus, for example in accordance with FIG. 8, an electronic control unit SE can then be provided, which implements the mathematical model MM and which uses an acceleration signal s₂ provided by an acceleration sensor 2 of the electric bicycle 1 and a rotational speed signal s₃ for the rotational speed of the bottom bracket shaft T, provided by a rotation angle sensor 3 of the electric bicycle 1, in order to estimate therefrom a torque at the bottom bracket shaft T. On the basis of this estimated/calculated torque, the electronic control unit SE controls the at least one drive motor A with the aid of a control signal s^{A}, via which the assistance power is specified.

Alternatively, the drive system can additionally comprise a torque sensor 4, via which the torque Mₘ actually applied by muscle power to the bottom bracket shaft T can be measured directly. The electronic control unit SE receives torque signals s₄ from said torque sensor 4 of the electric bicycle 1, which signals the electronic control unit SE uses for generating the control signal s_{A}. The torque M_{c} calculated with the aid of the mathematical model MM using the acceleration signal s₂ and the rotational speed signal s₃ is used here, by the electronic control unit SE, (a) for checking the plausibility of the measured values delivered by the torque sensor 4 and/or (b) as a fallback level for exclusive control of the drive motor 4 in the case of a malfunction or a failure of the torque sensor 4.

### LIST OF REFERENCE SIGNS

1 electric bicycle
10 front wheel
11 back wheel
12 chain (transmission element)
2 acceleration sensor
3 rotation angle sensor
4 torque sensor
A drive motor
B signal region
f direction of travel
IMU inertial measurement unit
M_{c} calculated torque
m_{f}, m_{IMU}, m_{q}, measured data
mₛ, mᵥ, m_{T}
MM mathematical model
Mₘ measured, actual torque
m_{MA,s}, m_{MA,q}, m_{MA,f} moving average values
q transverse direction
s₂ acceleration signal
s₃ rotational speed signal
s₄ torque signal
s_{A} control signal
SE electronic control unit
T bottom bracket shaft
v vertical direction

1. A drive system for an electric bicycle, comprising
a bottom bracket shaft for applying a drive power, by muscle power, for moving the electric bicycle forward,
at least one drive motor for providing an assistance power, generated by external power, in addition to the drive power, and
an electronic control unit for controlling the assistance power provided via the at least one drive motor, wherein
the drive system comprises at least one acceleration sensor for providing an acceleration signal that is representative of the acceleration of the electric bicycle, and at least one rotation angle sensor for providing a rotational speed signal that is representative of a rotational speed of the bottom bracket shaft, and
the electronic control unit is configured to use the acceleration signal and the rotational speed signal to calculate a torque applied to the bottom bracket shaft by muscle power and to control the assistance power on the basis of the calculated torque.

2. The drive system according to claim 1, wherein a mathematical model is stored in the electronic control unit, via which model calculation of the torque from the acceleration signal and the rotational speed signal is made possible.

3. The drive system according to claim 2, wherein the stored mathematical model comprises at least one of a sine transformer and a cosine transformer, via which the acceleration signal for calculating the torque is supplied to at least one of a sine transformation and a cosine transformation.

4. The drive system according to claim 1, wherein the drive system additionally comprises at least one torque sensor for measuring the actual torque currently applied to the bottom bracket shaft by muscle power.

5. The drive system according to claim 4, wherein the electronic control unit is configured to use the measured actual torque for controlling the assistance power, and to use the calculated torque for checking the plausibility of the measurement of the actual torque by the at least one torque sensor.

6. The drive system according to claim 4, wherein the drive system can be operated in at least a first operating mode and at least a second operating mode, wherein in the at least one first operating mode the assistance power is dependent on the actual torque measured by the at least torque sensor, and in the at least one second operating mode the assistance power is dependent on the calculated torque.

7. The drive system according to claim 6, wherein the electronic control unit is configured, in the event of a malfunction or a failure of the at least one torque sensor, to switch from the first operating mode into the second operating mode.

8. (canceled)

9. A method for controlling a drive system of an electric bicycle, in which a drive power can be applied by muscle power via a bottom bracket shaft for moving the electric bicycle forward, and an assistance power can be applied in addition to the drive power, by external power, via at least one drive motor operated in a travel mode, wherein
a torque applied to the bottom bracket shaft by muscle power is calculated using an acceleration signal representative of the acceleration of the electric bicycle and a rotational speed signal representative of a rotational speed of the bottom bracket shaft, and the assistance power is controlled on the basis of the calculated torque.

10. The method according to claim 9, wherein the torque is calculated with the aid of a mathematical model which includes the acceleration signal and the rotational speed signal as input variables.

11. The method according to claim 10, wherein, for calculating the torque, at least one of a sine transformation and a cosine transformation of the acceleration signal is carried out by means of the stored mathematical model.

12. The method according to claim 9, wherein the drive system additionally comprises at least one torque sensor for measuring an actual torque currently applied to the bottom bracket shaft by muscle power.

13. The method according to claim 12, wherein the measured actual torque is used for controlling the assistance power, wherein the plausibility of the measurement of the actual torque is checked by the at least one torque sensor with the calculated torque.

14. The method according to claim 12, wherein the drive system can be operated in at least a first operating mode and at least a second operating mode, wherein in the at least one first operating mode the assistance power is dependent on the actual torque measured by the at least torque sensor, and in the at least one second operating mode the assistance power is dependent on the calculated torque.

15. The method according to claim 14, wherein, in the event of a malfunction or a failure of the at least one torque sensor, a switch is made from the first operating mode into the second operating mode.

16. A computer program product comprising instructions which, when executed by at least one processor of an electronic control unit for a drive system of an electric bicycle, cause the at least one processor to carry out a method for controlling a drive system of the electric bicycle, in which a drive power can be applied by muscle power via a bottom bracket shaft for moving the electric bicycle forward, and an assistance power can be applied in addition to the drive power, by external power, via at least one drive motor operated in a travel mode, wherein a torque applied to the bottom bracket shaft by muscle power is calculated using an acceleration signal representative of the acceleration of the electric bicycle and a rotational speed signal representative of a rotational speed of the bottom bracket shaft, and the assistance power is controlled on the basis of the calculated torque.
